(19) United States
(12) Patent Application Publication
(10) Pub. No.: US 2025/0188253 A1
(43) Pub. Date: Jun. 12, 2025

(54) METHOD FOR PREPARING POLYMER SOLUTION FOR ELECTRODE SLURRY

(71) Applicant: LG ENERGY SOLUTION, LTD., Seoul (KR)

(72) Inventors: Suk-In NOH, Daejeon (KR); Na-Hyun KIM, Daejeon (KR); Sang-Jun PARK, Daejeon (KR); Hwi-Soo YANG, Daejeon (KR); Hyung-Suk CHO, Daejeon (KR)

(21) Appl. No.: 18/836,737

(22) PCT Filed: Feb. 21, 2023
(86) PCT No.: PCT/KR2023/002488

§ 371 Date: Aug. 7, 2024

(30) Foreign Application Priority Data
Mar. 2, 2022 (KR) 10-2022-0026843

(51) Int. Cl. C08L 1/28; H01M 4/62

(52) U.S. Cl. CPC C08L 1/286; H01M 4/62; C08L 2201/54; C08L 2203/20

(57) ABSTRACT

The present disclosure relates to a method for preparing a polymer solution for an electrode slurry. According to the present disclosure, there is provided a method for preparing a polymer solution for an electrode slurry, which includes a step of obtaining a mixture solution by mixing a water-soluble polymer and a water-based solvent, and a step of irradiating ultraviolet (UV) light to the mixture solution for a predetermined time.

### CROSS-REFERENCE TO RELATED APPLICATION(S)

This application is a National Phase entry pursuant to 35 U.S.C. § 371 of International Application No. PCT/KR2023/002488, filed on Feb. 21, 2023, and claims the benefit of and priority to Korean Patent Application No. 10-2022-0026843, filed on Mar. 2, 2022, with the Korean Intellectual Property Office, the disclosures of which are incorporated herein by reference in their entirety as if fully set forth herein.

### TECHNICAL FIELD

The present disclosure relates to a method for preparing a polymer solution for an electrode slurry for use in a secondary battery, and an electrode slurry for a secondary battery prepared therefrom.

### BACKGROUND

With the technological development and increased demand for mobile devices, the demand for secondary batteries as an energy source is increasing rapidly. Among such secondary batteries, lithium secondary batteries that exhibit high energy density and operating potential, long cycle life and low self-discharge rate have been commercialized and used widely.

An electrode of a lithium secondary battery is fabricated by mixing a positive electrode active material or a negative electrode active material with a binder resin component and dispersing the mixture in a solvent to prepare a slurry, applying the slurry on the surface of an electrode current collector, and then forming a mixture layer after drying the same.

The negative electrode slurry is generally classified into water-based and organic-based slurries. The water-based slurry is used in the general battery industry because it is advantageous in terms of price. A graphite-based active material which accounts for the most part of the negative electrode slurry is mainly dispersed in water.

However, since the graphite-based active material is generally hydrophobic, it is not dispersed easily in water and sedimentation occurs in the slurry over time, which can cause result in storage stability problems of the slurry. Specifically, since attempts are being made to increase the solid content in the negative electrode slurry for the purpose of increasing the loading amount of the negative electrode, improving the efficiency during a drying process, improving the migration of a binder, etc., the non-uniformity problem of the solid content in the slurry is becoming more prominent due to the dispersibility problem of the graphite-based active material and the storage stability of the slurry caused by the increased solid content. The dispersibility problem causes filter clogging during the transfer of the negative electrode slurry, which reduces the efficiency of the entire lithium secondary battery manufacturing process. In addition, the decreased storage stability of the slurry is an important issue because it causes different compositions in different parts of the negative electrode through formation of a nonuniform coating layer during the preparation of the negative electrode. In order to solve the dispersibility and storage stability problems of the graphite-based active material described above, the use of a thickener has been attempted.

For instance, there have been attempts to disperse the graphite-based active material and ensure the viscosity of the slurry using a thickener in the water-based negative electrode slurry. If the thickener itself has low solubility in water, a method of dissolving the thickener in distilled water in advance to prepare a thickening solution and using the same for preparation of a slurry is also adopted. However, in large-scale production conditions, in which the thickening solution needs to be stored for up to a week, the thickening solution may change over time, such as decrease in viscosity, etc., thereby reducing workability during an electrode coating process and deteriorating the quality of the electrode itself.

Accordingly, it is still necessary to develop an electrode slurry that can improve the dispersibility and storage stability of the graphite-based active material and improve the quality of the electrode.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

### Technical Problem

In an aspect, the present disclosure is directed to providing a polymer solution that can improve the dispersibility and storage stability of a graphite-based active material in an electrode slurry for use in preparation of an electrode for a secondary battery, and a method for preparing the same.

In another aspect, the present disclosure is directed to providing a polymer solution for preparing the electrode slurry described above, which has appropriate viscosity and improved stability over time, and a method for preparing the same.

In another aspect, the present disclosure is directed to providing an electrode slurry with improved dispersibility and storage stability of a graphite-based active material, using the polymer solution described above, an electrode prepared using the same, and a lithium secondary battery including the electrode.

### Technical Solution

In an aspect of the present disclosure, there is provided a method for preparing a polymer solution for an electrode slurry according to the following exemplary embodiments. According to a first exemplary embodiment, there is provided a method for preparing a polymer solution for an electrode slurry, which includes: a step of obtaining a mixture solution by mixing a water-soluble polymer and a water-based solvent; and a step of irradiating ultraviolet (UV) light to the mixture solution for a predetermined time.

According to a second exemplary embodiment, in the first exemplary embodiment, the water-soluble polymer may include polyvinylidene fluoride (PVDF), polyvinyl alcohol (PVA), starch, polyvinylpyrrolidone (PVP), polytetrafluoroethylene (PTFE), polyethylene (PE), polypropylene (PP), ethylene-propylene-diene terpolymer (EPDM), sulfonated EPDM, styrene-butadiene rubber, fluorine rubber, methyl cellulose (MC), ethyl cellulose (EC), carboxymethyl cellulose (CMC), carboxyethyl cellulose (CEC), hydroxyethyl cellulose, benzyl cellulose, trityl cellulose, cyanoethyl cellulose, aminoethyl cellulose, nitrocellulose, cellulose ether, regenerated cellulose, hydroxypropyl cellulose (HPC), copolymers thereof, or mixtures thereof.

According to a third exemplary embodiment, in the first or second exemplary embodiment, the water-soluble polymer may include carboxymethyl cellulose (CMC).

According to a fourth exemplary embodiment, in any of the first to third exemplary embodiments, the water-soluble polymer may have a weight-average molecular weight (M_{w}) of 500,000 to 5,000,000 g/mol.

According to a fifth exemplary embodiment, in any of the first to fourth exemplary embodiments, the water-soluble polymer may be in a form of a powder.

According to a sixth exemplary embodiment, in any of the first to fifth exemplary embodiments, the water-soluble polymer may be included in an amount of 0.1-5 wt % based on the total weight of the water-based solvent.

According to a seventh exemplary embodiment, in any of the first to sixth exemplary embodiment, the wavelength of the irradiated ultraviolet light may be 240 to 400 nm.

According to an eighth exemplary embodiment, in any of the first to seventh exemplary embodiments, the wavelength of the irradiated ultraviolet light may be 240 to 260 nm.

According to a ninth exemplary embodiment, in any of the first to eighth exemplary embodiments, the ultraviolet light may be irradiated while the mixture solution is being prepared.

According to a tenth exemplary embodiment, in any of the first to ninth exemplary embodiments, a ratio (%) of the ultraviolet light irradiation time to the total mixing time may be 1 to 100%.

According to an eleventh exemplary embodiment, in any of the first to tenth exemplary embodiments, the ultraviolet light may be irradiated throughout the total mixing time or irradiated for only a portion of the mixing time.

In another aspect of the present disclosure, there is provided a polymer solution for an electrode slurry according to the following exemplary embodiment.

According to a twelfth exemplary embodiment, there is provided a polymer solution for an electrode slurry, which includes: a water-soluble polymer; and a water-based solvent, wherein the polymer solution exhibits a viscosity change defined by Equation 1 of −20 to 5% when stored at 23° C. for 7 days:

$$Viscosity change ( \% ) = ( Vis ( d ) - Vis ( i ) ) / Vis ( i ) \times 100 \qquad [ Equation 1 ]$$

In Equation 1,
Vis(i) is the initial viscosity of an electrode slurry,
Vis(d) is the viscosity measured after storing for d days (1≤d≤7), and
the viscosity values are measured at 23° C. using a Brookfield viscometer (DV2T viscometer, 12 rpm, spindle 24).

According to another aspect of the present disclosure, there is provided an apparatus for preparing a polymer solution according to the following exemplary embodiment.

According to a thirteenth exemplary embodiment, there is provided an apparatus for preparing a polymer solution for an electrode slurry, which includes: a mixing unit; and an ultraviolet light irradiation unit configured to irradiate ultraviolet light to a mixture loaded in the mixing unit.

### Advantageous Effects

A method for preparing a polymer solution for an electrode slurry according to an exemplary embodiment of the present disclosure can improve the dispersibility and storage stability of a graphite-based active material in an electrode slurry when preparing an electrode for use in a secondary battery.

The method for preparing a polymer solution for an electrode slurry according to an exemplary embodiment of the present disclosure can improve not only workability during preparation of the electrode slurry but also the quality of the electrode slurry, the electrode and the secondary battery due to appropriate viscosity and improved stability over time.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not to be construed as being limited to the drawings.

FIG. 1 shows a result of measuring the viscosity of polymer solutions prepared according to an exemplary embodiment of the present disclosure with the lapse of storage time.

FIG. 2 shows the surface image of an electrode slurry wherein a graphite-based active material is dispersed using a polymer solution for an electrode slurry prepared in Comparative Example 1 immediately after preparation.

FIG. 3 shows the surface image of an electrode slurry wherein a graphite-based active material is dispersed using a polymer solution for an electrode slurry prepared in Comparative Example 2 immediately after preparation.

FIG. 4 shows the image of an electrode slurry wherein a graphite-based active material is dispersed using a polymer solution for an electrode slurry prepared in Comparative Example 1 after passing through a filter.

FIG. 5 shows the image of an electrode slurry wherein a graphite-based active material is dispersed using a polymer solution for an electrode slurry prepared in Comparative Example 2 after passing through a filter.

### DETAILED DESCRIPTION

Hereinafter, the present disclosure is described in detail.

A method for preparing a polymer solution for an electrode slurry according to an aspect of the present disclosure includes: a step of obtaining a mixture solution by mixing a water-soluble polymer and a water-based solvent; and a step of irradiating ultraviolet (UV) light to the mixture solution for a predetermined time.

In the present specification, the polymer solution may be used for the purpose of dispersing a solid content such as an active material, etc. when preparing an electrode slurry for use in manufacturing an electrode of a secondary battery. But, the use of the polymer solution is not limited thereto.

The step of obtaining the mixture solution is a step wherein mixing the water-soluble polymer and the water-based solvent so that the water-soluble polymer is dispersed uniformly.

The mixing for obtaining the mixture solution may be performed by various methods for mixing the water-soluble polymer and the water-based solvent, without special limitation.

In an exemplary embodiment of the present disclosure, the water-soluble polymer is not specially limited as long as it can function as a thickener in the electrode slurry. Due to the thickening function of the water-soluble polymer, an advantageous effect can be exhibited in terms of the dispersibility of an active material, for example, graphite, silicon compounds, silicon oxide/carbide composites or mixtures thereof, particularly in the electrode slurry.

In an exemplary embodiment of the present disclosure, the water-soluble polymer may include a biodegradable polymer. For example, the water-soluble polymer may have a biodegradable property and can be degraded by bacteria present in a stirring tank or a raw material supply hopper when a polymer solution prepared therefrom is stored in the stirring tank or the hopper for use in the preparation of an electrode slurry.

In another exemplary embodiment of the present disclosure, the water-soluble polymer may include, for example, polyvinylidene fluoride (PVDF), polyvinyl alcohol (PVA), starch, polyvinylpyrrolidone (PVP), polytetrafluoroethylene (PTFE), polyethylene (PE), polypropylene (PP), ethylene-propylene-diene terpolymer (EPDM), sulfonated EPDM, styrene-butadiene rubber, fluorine rubber, methyl cellulose (MC), ethyl cellulose (EC), carboxymethyl cellulose (CMC), carboxyethyl cellulose (CEC), hydroxyethyl cellulose, benzyl cellulose, trityl cellulose, cyanoethyl cellulose, aminoethyl cellulose, nitrocellulose, cellulose ether, regenerated cellulose, hydroxypropyl cellulose (HPC), copolymers thereof or mixtures thereof, although not being limited thereto.

In an exemplary embodiment of the present disclosure, the water-soluble polymer may include carboxymethyl cellulose (CMC). When the water-soluble polymer includes carboxymethyl cellulose, an advantageous effect may be achieved in terms of the dispersibility and phase stability of an electrode slurry, specifically a negative electrode water-based slurry for a lithium-ion secondary battery, although the present disclosure is not limited thereto. More specifically, when the water-soluble polymer includes carboxymethyl cellulose, superior dispersibility of an active material in the electrode slurry may be achieved and appropriate viscosity may be conferred to the electrode slurry due to superior solubility of the carboxymethyl cellulose in the water-based electrode slurry. As a result, an advantageous effect may be exhibited in terms of suppressing the degree of reaggregation or sedimentation of the active material dispersed in the electrode slurry.

In another exemplary embodiment of the present disclosure, the water-soluble polymer may have a weight-average molecular weight (M_{w}) of, for example, 500,000-5,000,000 g/mol. Specifically, the water-soluble polymer may have a weight-average molecular weight (M_{w}) of 750,000 g/mol or higher, 1,000,000 g/mol or higher or 1,500,000 g/mol or higher, and 4,000,000 g/mol or lower, 3,000,000 g/mol or lower or 2,500,000 g/mol or lower. When the weight-average molecular weight (M_{w}) of the water-soluble polymer is within the above-described ranges, an advantageous effect may be achieved in terms of the dispersion or thickening an electrode slurry, specifically a negative electrode water-based slurry for a lithium-ion secondary battery, although the present disclosure is not limited thereto. The weight-average molecular weight (M_{w}) may be a value measured by gel permeation chromatography (GPC).

In an exemplary embodiment of the present disclosure, the water-soluble polymer may be in the form of a powder.

In an exemplary embodiment of the present disclosure, the water-based solvent is not specially limited as long as it can dissolve the water-soluble polymer. For example, the water-based solvent may include water.

In another exemplary embodiment of the present disclosure, the water-based solvent may be water alone.

In an exemplary embodiment of the present disclosure, the water-soluble polymer may be mixed at a content of, for example, 0.1-5 wt % based on the total weight of the water-based solvent. Specifically, the water-soluble polymer may be contained at a content of 0.1 wt % or higher, 0.5 wt % or higher or 1 wt % or higher, and 5 wt % or lower, 4.5 wt % or lower, 4 wt % or lower, 3.5 wt % or lower or 3 wt % or lower, based on the total weight of the water-based solvent. When the content of the water-soluble polymer is within the above-described ranges, an advantageous effect may be achieved in terms of the convenience of preparing an electrode slurry, specifically a negative electrode slurry, and the improvement of the solid content in the negative electrode slurry, although the present disclosure is not limited thereto.

In an exemplary embodiment of the present disclosure, in the step of obtaining the mixture solution by mixing the water-soluble polymer and the water-based solvent, the water-soluble polymer and the water-based solvent may be added to a mixer either simultaneously or sequentially. The order and method of the addition are not specially limited.

In another exemplary embodiment of the present disclosure, in the step of obtaining the mixture solution by mixing the water-soluble polymer and the water-based solvent, the water-based solvent may be added to a mixer first, and then a predetermined amount of the water-soluble polymer may be added. This may be advantageous in improving the quality of the finally prepared polymer solution for an electrode slurry by improving the scattering of fine powder occurring during large-scale production.

The method for preparing a polymer solution for an electrode slurry of the present disclosure includes a step of irradiating ultraviolet (UV) light to the mixture solution prepared above for a predetermined time.

In an exemplary embodiment of the present disclosure, a sterilizing effect on the bacteria proliferating in the mixer may be achieved by irradiating the ultraviolet light to the mixture solution of the water-soluble polymer and the water-based solvent. By preventing or reducing the degradation of the water-soluble polymer by the bacteria proliferating in the mixer, the viscosity of the polymer solution for an electrode slurry may be maintained appropriately and the stability over time may be improved, although the mechanism of the present disclosure is not limited thereto.

In particular, as described above, a water-soluble polymer, e.g., carboxymethyl cellulose, which has superior properties of improving the dispersibility of an active material and suppressing the reaggregation or sedimentation of the dispersed active material, may exhibit an insignificant effect when preparing an electrode slurry because of its biodegradable property. The effect of the biodegradable polymer such as carboxymethyl cellulose, etc. contained in the mixture solution as the water-soluble polymer may be improved remarkably by the irradiation of the ultraviolet light.

In the step of irradiating the ultraviolet light to the mixture solution, the mixture solution may be prepared and then the ultraviolet light may be irradiated, the ultraviolet light may be irradiated while the mixture solution is being prepared, or the ultraviolet light may be irradiated after the preparation of the mixture solution has been completed. That is to say, the order of the irradiation of the ultraviolet light is not specially limited.

In another exemplary embodiment of the present disclosure, in the step of irradiating the ultraviolet light, the ultraviolet light may be irradiated in a shielding container to prevent or minimize of the exposure of the ultraviolet light to the human body.

In an exemplary embodiment of the present disclosure, the irradiated ultraviolet light may have a wavelength of, for example, 240-400 nm. Although the wavelength of the ultraviolet light may be 10-400 nm in general, if the wavelength of the ultraviolet light is shorter than 240 nm, the stability of the polymer solution may be deteriorated due to the generation of ozone. Therefore, the lower limit of the wavelength of the ultraviolet light may be set to 240 nm.

In another exemplary embodiment of the present disclosure, if a means of reducing or preventing the generation of ozone by the irradiated ultraviolet light is equipped, the wavelength of the ultraviolet light may also be shorter than 240 nm as long as the sterilizing effect is not impaired.

In another exemplary embodiment of the present disclosure, the wavelength of the ultraviolet light may be specifically 240 nm or longer, 245 nm or longer, 250 nm or longer, 254 nm or longer or 280 nm or longer, and 400 nm or shorter, 380 nm or shorter, 370 nm or shorter, 360 nm or shorter, 350 nm or shorter, 340 nm or shorter, 320 nm or shorter, 310 nm or shorter, 300 nm or shorter, 290 nm or shorter, 280 nm or shorter or 260 nm or shorter. More specifically, the wavelength of the ultraviolet light may be 240-300 nm or 240-260 nm. Further more specifically, the wavelength of the ultraviolet light may be 250-260 nm. When the wavelength of the ultraviolet light is within the above ranges, an advantageous effect may be achieved in terms of the sterilization of the water-soluble polymer in the mixture solution and prevention of degradation by bacteria, although the present disclosure is not limited thereto.

The irradiation time for which the ultraviolet light is irradiated by may be determined in consideration of the wavelength of the irradiated ultraviolet light, without special limitation.

In another exemplary embodiment of the present disclosure, the ultraviolet light may be irradiated for, for example, 1-300 minutes, specifically 10-180 minutes, when the total weight of the water-soluble polymer and the water-based solvent is 100 g, and the irradiation time may be increased proportionally to the total weight of the water-soluble polymer and the water-based solvent.

In an exemplary embodiment of the present disclosure, the ratio of the ultraviolet light irradiation time to the total mixing time may be, for example, 1-100%. Specifically, the ratio of the ultraviolet light irradiation time to the total mixing time may be 30-90%, 50-90%, 50-80% or 60-70%. When the ratio of the ultraviolet light irradiation time to the total mixing time is within the above ranges, an advantageous effect may be achieved in terms of the stability of the water-soluble polymer and process efficiency, although the present disclosure is not limited thereto.

In another exemplary embodiment of the present disclosure, the ultraviolet light may be irradiated after a predetermined time has passed after the mixing of the water-soluble polymer and the water-based solvent.

For example, the mixture solution obtained by mixing the water-soluble polymer and the water-based solvent may be stored in a storage container until an electrode slurry is prepared. After the mixture solution has been stored in the storage container, a polymer solution for an electrode slurry may be prepared by irradiating ultraviolet light to the stored mixture solution when preparing an electrode slurry.

In an exemplary embodiment of the present disclosure, stirring may be performed in the step of mixing the water-soluble polymer and the water-based solvent.

In an exemplary embodiment of the present disclosure, in the method for preparing a polymer solution for an electrode slurry, a polymer solution for an electrode slurry may be prepared by irradiating ultraviolet light while stirring the mixture solution of the water-soluble polymer and the water-based solvent in the mixer.

In an exemplary embodiment of the present disclosure, in the step of mixing the water-soluble polymer and the water-based solvent, the ultraviolet light may be irradiated for only a portion of the total mixing time.

In another exemplary embodiment of the present disclosure, the method for preparing a polymer solution for an electrode slurry may include the mixing step and the ultraviolet light irradiation step once or more times irrelevant of their order.

In another exemplary embodiment of the present disclosure, in the method for preparing a polymer solution for an electrode slurry, after the water-soluble polymer and the water-based solvent added to the mixer have been stirred for a predetermined time, ultraviolet light irradiation and stirring may be performed simultaneously.

According to the method, a polymer solution that can be used to disperse a solid content such as an active material, etc. when preparing an electrode slurry for use in a secondary battery may be prepared.

In an exemplary embodiment of the present disclosure, a polymer solution for an electrode slurry prepared by the above-described method may exhibit superior stability over time with the lapse of storage time while having viscosity useful for preparation of an electrode slurry.

In an exemplary embodiment of the present disclosure, the manufacturing process of the electrode may be carried out, in order to improve process efficiency, by preparing a large amount of the polymer solution for an electrode slurry at once and then introducing the same for preparation of an electrode slurry after dividing into several portions. Therefore, it is preferred that the polymer solution for an electrode slurry has superior stability over time in terms of the efficiency of the electrode manufacturing process. For example, if the prepared polymer solution for an electrode slurry has stability over time for at least 7 days after the preparation, it is advantageous in that the efficiency of the electrode manufacturing process can be maximized.

In another aspect of the present disclosure, the polymer solution for an electrode slurry is prepared according to the method described above and exhibits a viscosity change defined by [Equation 1] of −20 to 5% when stored at 23° C. for 7 days.

$$Viscosity change ( \% ) = ( Vis ( d ) - Vis ( i ) ) / Vis ( i ) \times 100 \qquad [ Equation 1 ]$$

In Equation 1,
Vis(i) is the initial viscosity of an electrode slurry,
Vis(d) is the viscosity measured after storing for d days (1≤d≤7), and
the viscosity values are measured at 23° C. using a Brookfield viscometer (DV2T viscometer, 12 rpm, spindle 24).

In an exemplary embodiment of the present disclosure, the polymer solution for an electrode slurry may exhibit a viscosity of, for example, 5,000-50,000 cps at 23° C. after being stored for 7 days. Specifically, the polymer solution for an electrode slurry may exhibit a viscosity of 7,000-30,000 cps or 7,500-10,000 cps at 23° C. after being stored for 7 days. If the viscosity of the polymer solution for an electrode slurry after being stored for 7 days is within the above ranges, an advantageous effect may be achieved in terms of quality control of the electrode slurry in large-scale production, although the present disclosure is not limited thereto.

In another exemplary embodiment of the present disclosure, the change in the viscosity of the polymer solution for an electrode slurry with the lapse of storage time when stored for 7 days may be maintained within ±20%, specifically within −20 to +5%. The change in the viscosity may be specifically within ±5%, within ±4.5%, within ±4%, within ±3.5%, within ±3%, within ±2%, within ±1%, within ±0.8%, within ±0.7%, within ±0.6%, within ±0.5%, within ±0.3% or within ±0.2%.

In another exemplary embodiment of the present disclosure, the increase in the viscosity of the polymer solution for an electrode slurry may mean that the water-soluble polymer present in the polymer solution for an electrode slurry exists stably without being degraded and is swollen. Therefore, the change in the viscosity of the polymer solution for an electrode slurry with the lapse of storage time for 7 days may be specifically within +5%, within +4%, within +3%, within +2%, within +1%, within +0.8%, within +0.7%, within +0.6%, within +0.5%, within +0.3% or within +0.2%, although the present disclosure is not limited thereto.

An apparatus for preparing a polymer solution according to another aspect of the present disclosure includes a mixing unit and an ultraviolet light irradiation unit for irradiating ultraviolet light to a mixture loaded in the mixing unit.

In an exemplary embodiment of the present disclosure, the mixing unit may be a common mixer used to prepare a polymer solution and is not specially limited in type. For example, the mixing unit may include various mixers such as a PD mixer, a BTM mixer, a Soken mixer, a Corona mixer, etc.

In another exemplary embodiment of the present disclosure, the ultraviolet light irradiation unit may include any device capable of irradiating ultraviolet light having the wavelength described above and is not specially limited in type.

The polymer solution for an electrode slurry may be used as a dispersing solution for dispersing a solid content such as an active material in an electrode slurry for use in the preparation of an electrode of a secondary battery or as a thickening solution.

In the present disclosure, the electrode may be a positive electrode or a negative electrode included in a secondary battery.

In the present disclosure, the active material may be a negative electrode active material or a positive electrode active material.

In an exemplary embodiment of the present disclosure, the negative electrode active material may be, for example, graphite such as natural graphite, artificial graphite, etc.; carbon black such as acetylene black, ketjen black, channel black, furnace black, lamp black, thermal black, etc.; conductive fiber such as carbon fiber, metal fiber, etc.; fluorocarbon; metal powder such as aluminum, nickel powder, etc.; conductive whisker such as zinc oxide, potassium titanate, etc.; conductive metal oxide titanium oxide, etc.; conductive material such as a polyphenylene derivative, etc., or the like.

In another exemplary embodiment of the present disclosure, the negative electrode active material may include a graphite material.

In another exemplary embodiment of the present disclosure, the positive electrode active material may include, for example, one or more of: a lithium transition metal oxide; a lithium metal iron phosphate; lithium nickel manganese cobalt oxide; an oxide in which lithium nickel manganese cobalt oxide is partly substituted with another transition metal; or combinations thereof, although not being limited thereto. Specifically, the positive electrode active material may be, for example, a layered compound such as lithium cobalt oxide (LiCoO₂), lithium nickel oxide (LiNiO₂), etc. or a compound substituted with one or more transition metal; lithium manganese oxide such as Li₁₊ₓMn₂₋ₓO₄ (wherein 0≤x≤0.33), LiMnO₃, LiMn₂O₃, LiMnO₂, etc.; lithium copper oxide (Li₂CuO₂); vanadium oxide such as LiV₃O₈, LiV₃O₄, V₂O₅, Cu₂V₂O₇, etc.; Ni site-type lithium nickel oxide represented by LiNi₁₋ₓMₓO₂ (wherein M is Co, Mn, Al, Cu, Fe, Mg, B or Ga and 0.01≤x≤0.3); a lithium manganese composite oxide represented by LiMn₂₋ₓMₓO₂ (wherein M is Co, Ni, Fe, Cr, Zn or Ta and 0.01≤x≤0.1) or Li₂Mn₃MO₈ (wherein, M is Fe, Co, Ni, Cu or Zn); a lithium metal phosphate LiMPO₄ (wherein M is Fe, CO, Ni, or Mn); lithium nickel manganese cobalt oxide Li₁₊ₓ(NiₐCo_{b}Mn_{c})₁₋ₓO₂ (0≤x≤0.03, 0.3≤a≤0.95, 0.01≤b≤0.35, 0.01≤c≤0.5 and a+b+c=1); an oxide Liₐ[Ni_{b}Co_{c}Mn_{d}Alₑ]_{1-f}M1_{f}O₂ wherein lithium nickel manganese cobalt oxide is partially substituted with aluminum (M1 is one or more selected from a group consisting of Zr, B, W, Mg, Ce, Hf, Ta, La, Ti, Sr, Ba, F, P and S, 0.8≤a≤1.2, 0.5≤b≤0.99, 0<c<0.5, 0<d<0.5, 0.01≤e≤0.1 and 0≤f≤0.1); an oxide Li₁₊ₓ(NiₐCo_{b}Mn_{c}M_{d})₁₋ₓO₂ wherein lithium nickel manganese cobalt oxide is partially substituted with another transition metal (0≤x≤0.03, 0.3≤a≤0.95, 0.01≤b≤0.35, 0.01≤c≤0.5, 0.001≤d≤0.03, a+b+c+d=1 and M is any one selected from a group consisting of Fe, V, Cr, Ti, W, Ta, Mg and Mo), a disulfide compound; Fe₂(MoO₄)₃, etc., although not being limited thereto. In addition, the positive electrode active material may also be a sulfide, a selenide, a halide, etc.

In the present disclosure, the secondary battery may be a lithium secondary battery including a lithium-metal secondary battery, a lithium-ion secondary battery, a lithium polymer secondary battery, a lithium-ion polymer secondary battery, etc.

### MODE FOR DISCLOSURE

Hereinafter, the present disclosure is described in further detail through examples. However, the following examples are only for illustrating the present disclosure and the scope of the present disclosure is not limited thereto.

### Preparation of Polymer Solutions for Electrode Slurry

### Comparative Example 1

A polymer solution was prepared by adding 0.7 kg of spherical carboxymethyl cellulose (CMC) powder having a weight-average molecular weight (M_{w}) of 2,000,000 g/mol and 34.3 kg of distilled water to a 50-L tank and stirring for 3 hours. The mixture was stirred using a BTM mixer under the condition of Anchor disper 50 rpm and Homo disper 1,000 rpm.

### Comparative Example 2

A polymer solution was prepared in the same manner as in Comparative Example 1 except that polyvinylidene propylene (PVP) with a weight-average molecular weight (M_{w}) of 2,000,000 g/mol was used instead of carboxymethyl cellulose (CMC).

### Example 1

A polymer solution was prepared in the same manner as in Comparative Example 1 except that, after stirring for 1 hour, ultraviolet light with a wavelength of 254 nm was irradiated using two UV lamps (20 W) equipped above the BTM mixer while stirring for 2 hours.

### Example 2

A polymer solution was prepared in the same manner as in Example 1 except that ultraviolet light with a wavelength of 280 nm was irradiated.

### Example 3

A polymer solution was prepared in the same manner as in Example 1 except that ultraviolet light with a wavelength of 300 nm was irradiated.

### Example 4

A polymer solution was prepared in the same manner as in Example 1 except that ultraviolet light with a wavelength of 360 nm was irradiated.

### [Evaluation of Physical Properties of Polymer Solutions]

### Measurement of Initial Viscosity

The polymer solutions prepared in Comparative Example 1 and Examples 1˜4 were stored in a PE container (bottle) immediately after the preparation. The PE container was contained in an open system.

The viscosity of each polymer solution was measured at 23° C. using a Brookfield viscometer (DV2T viscometer, 12 rpm, spindle 24) immediately after the preparation. The result is given in Table 1.

### Evaluation of Change in Viscosity

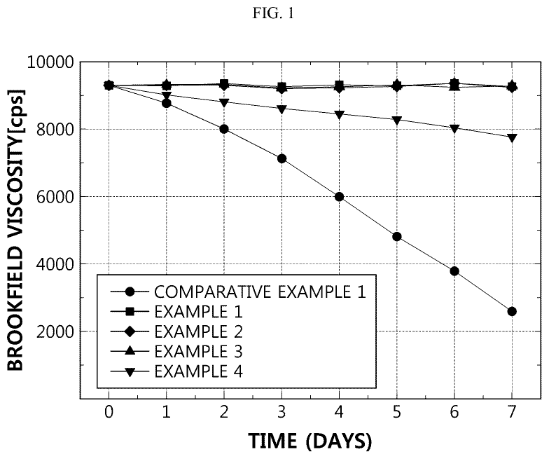

The viscosity of the polymer solutions prepared in Comparative Example 1 and Examples 1-4 was measured at 23° C. using the viscometer every 24 hours. The result is shown in Table 1 and FIG. 1.

The viscosity change calculated 7 days later according to [Equation 2] is given in Table 1.

$$Viscosity change ( \% ) = ( Vis ( 7 ) - Vis ( 0 ) ) / Vis ( 0 ) \times 100 \qquad [ Equation 2 ]$$

In Equation 2, Vis(i) is the initial viscosity of an electrode slurry, and Vis(7) is the viscosity measured after storing for 7 days.

### Evaluation of Dispersibility Depending on Water-Soluble Polymer

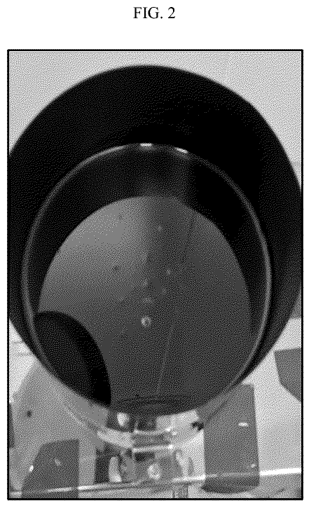

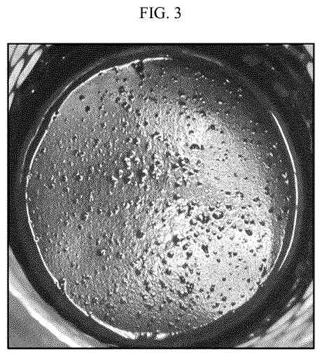

In order to evaluate the dispersibility of an active material depending on the water-soluble polymer, an electrode slurry was prepared by adding 100 g of graphite (POSCO) as a negative electrode active material to 105 mL of the polymer solution for an electrode slurry of Comparative Example 1 or Comparative Example 2 in a mixer and then stirring the mixture. The images of the electrode slurries immediately after the preparation are shown in FIG. 2 (Comparative Example 1) and FIG. 3 (Comparative Example 2).

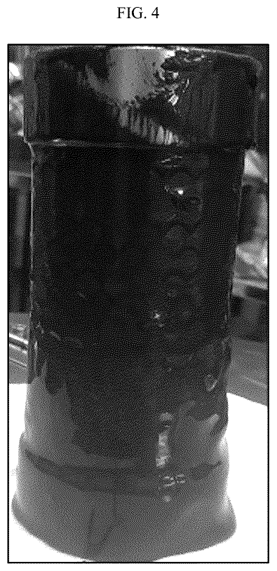

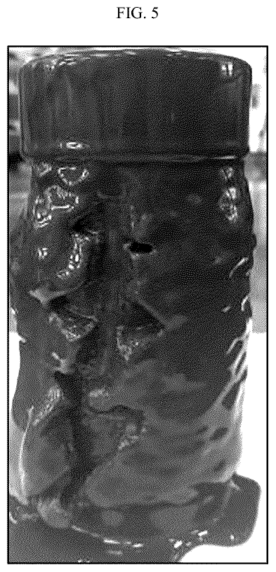

In addition, the images of the electrode slurries after passing through a filter (HCB filter cartridge, ROKI TECHNO) are shown in FIG. 4 (Comparative Example 1) and FIG. 5 (Comparative Example 2).

TABLE 1

| | | Brookfield viscosity of CMC solution [cps] | | | | | | | | |
|---|---|---|---|---|---|---|---|---|---|---|
| | | Immediately | | | | | | | | |
| | Wavelength | after | | | | | | | | Viscosity |
| | [nm] | preparation | 1 day | 2 days | 3 days | 4 days | 5 days | 6 days | 7 days | change (%) |
| Comp. | Off | 9283 | 8760 | 7980 | 7115 | 5961 | 4801 | 3785 | 2604 | −72.0 |
| Ex. 1 | | | | | | | | | | |
| Ex. 1 | 254 | 9223 | 9214 | 9323 | 9254 | 9328 | 9257 | 9312 | 9284 | 0.7 |
| Ex. 2 | 280 | 9208 | 9276 | 9280 | 9215 | 9187 | 9228 | 9315 | 9196 | −0.1 |
| Ex. 3 | 300 | 9316 | 9302 | 9291 | 9194 | 9243 | 9276 | 9227 | 9249 | −0.7 |
| Ex. 4 | 360 | 9247 | 9004 | 8796 | 8601 | 8445 | 8274 | 8008 | 7761 | −16.1 |

As seen from Table 1 and FIG. 1, the polymer solution prepared in Comparative Example 1 without irradiating ultraviolet light showed a viscosity comparable to that of the examples immediately after the preparation of the polymer solution, but showed poor stability over time with the lapse of storage time.

Also, as shown in FIG. 2 and FIG. 3, when the active material was dispersed in the CMC solution for an electrode slurry, the surface of the electrode slurry was smooth and no lump of undispersed active material was observed. In contrast, when the active material was dispersed in the PVP solution for an electrode slurry, lump of undispersed active material was observed on the surface of the electrode slurry.

In addition, as can be seen from FIG. 4 and FIG. 5, when the prepared electrode slurry was passed through a filter, the electrode slurry using the CMC solution for an electrode slurry (Comparative Example 1) passed through the filter without remaining undispersed active material. In contrast, the electrode slurry using the PVP solution for an electrode slurry (Comparative Example 2) showed filter clogging since the undispersed active material could not pass through the filter.

Accordingly, it was confirmed that the use of CMC in the polymer solution for an electrode slurry can result in superior dispersibility of the active material and, especially by irradiating ultraviolet light during the preparation of the polymer solution for an electrode slurry, the stability of the polymer solution for an electrode slurry over time can be ensured, thereby providing advantageous effects in terms of the preparation of an electrode slurry with superior dispersibility of the active material and the improvement of the performance of an electrode and a battery using the same.

Although the present disclosure has been described with reference to the examples and drawings, those having ordinary knowledge in the field to which the present disclosure belongs will be able to make various applications and modifications within the scope of the present disclosure based thereon.

1. A method for preparing a polymer solution for an electrode slurry, comprising:
a step of obtaining a mixture solution by mixing a water-soluble polymer and a water-based solvent; and
a step of irradiating ultraviolet (UV) light to the mixture solution for a predetermined time.

2. The method for preparing a polymer solution for an electrode slurry according to claim 1, wherein the water-soluble polymer comprises polyvinylidene fluoride (PVDF), polyvinyl alcohol (PVA), starch, polyvinylpyrrolidone (PVP), polytetrafluoroethylene (PTFE), polyethylene (PE), polypropylene (PP), ethylene-propylene-diene terpolymer (EPDM), sulfonated EPDM, styrene-butadiene rubber, fluorine rubber, methyl cellulose (MC), ethyl cellulose (EC), carboxymethyl cellulose (CMC), carboxyethyl cellulose (CEC), hydroxyethyl cellulose, benzyl cellulose, trityl cellulose, cyanoethyl cellulose, aminoethyl cellulose, nitrocellulose, cellulose ether, regenerated cellulose, hydroxypropyl cellulose (HPC), copolymers thereof, or mixtures thereof.

3. The method for preparing a polymer solution for an electrode slurry according to claim 21, wherein the water-soluble polymer comprises carboxymethyl cellulose (CMC).

4. The method for preparing a polymer solution for an electrode slurry according to claim 1, wherein the water-soluble polymer has a weight-average molecular weight (M_{w}) of 500,000 to 5,000,000 g/mol.

5. The method for preparing a polymer solution for an electrode slurry according to claim 1, wherein the water-soluble polymer is in a form of a powder.

6. The method for preparing a polymer solution for an electrode slurry according to claim 1, wherein the water-soluble polymer is included in an amount of 0.1-5 wt % based on the total weight of the water-based solvent.

7. The method for preparing a polymer solution for an electrode slurry according to claim 1, wherein the wavelength of the irradiated ultraviolet light is 240 to 400 nm.

8. The method for preparing a polymer solution for an electrode slurry according to claim 7, wherein the wavelength of the irradiated ultraviolet light is 240 to 260 nm.

9. The method for preparing a polymer solution for an electrode slurry according to claim 1, wherein the ultraviolet light is irradiated while the mixture solution is being prepared.

10. The method for preparing a polymer solution for an electrode slurry according to claim 1, wherein a ratio (%) of the ultraviolet light irradiation time to the total mixing time is 1 to 100%.

11. The method for preparing a polymer solution for an electrode slurry according to claim 1, wherein the ultraviolet light is irradiated throughout the total mixing time or irradiated for only a portion of the mixing time.

12. A polymer solution for an electrode slurry, comprising:
a water-soluble polymer; and
a water-based solvent,
wherein the polymer solution exhibits a viscosity change defined by Equation of −20 to 5% when stored at 23° C. for 7 days:
$$Viscosity change ( \% ) = ( Vis ( d ) - Vis ( i ) ) / Vis ( i ) \times 100 \qquad [ Equation 1 ]$$
wherein,
Vis(i) is the initial viscosity of an electrode slurry,
Vis(d) is the viscosity measured after storing for d days (1≤d≤7), and
the viscosity values are measured at 23° C. using a Brookfield viscometer (DV2T viscometer, 12 rpm, spindle 24).

13. An apparatus for preparing a polymer solution for an electrode slurry, comprising:
a mixing unit; and
an ultraviolet light irradiation unit configured to irradiate ultraviolet light to a mixture loaded in the mixing unit.
